(19) United States
(12) Patent Application Publication
(10) Pub. No.: US 2023/0353539 A1
(43) Pub. Date: Nov. 2, 2023

(54) Methods for automatically modifying firewall rules based on Internet Protocol (IP) addresses

(71) Applicant: Tommy Leroy Allen, Washington, UT (US)

(72) Inventor: Tommy Leroy Allen, Washington, UT (US)

(73) Assignee: Omni InfoSec LLC, Washington, UT (US)

(21) Appl. No.: 17/734,689

(22) Filed: May 2, 2022

(51) Int. Cl. H04L 9/40

(52) U.S. Cl. CPC H04L 63/0263

(57) ABSTRACT

Methods for automatically modifying firewall rules based on Internet Protocol (IP) addresses.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to a computer program that retrieves a configuration file from a remote location, stores the configuration data from file to memory, connects to network hosts, sniffs network packets, extracts Internet Protocol (IP) addresses from network packets, cross-references them with configuration data stored in memory, and modifying the firewall rules for blocking IP addresses from sending and receiving network packets.

### BACKGROUND OF THE INVENTION

Computer hacking continues to be a major problem for all companies with hardware that are connected to the Internet. Having a firewall and setting rules is a cumbersome task that takes a significant amount of time to maintain.

What is needed is a method for automating this process to prevent malicious internal and external programs from communicating with other devices on the Internet or Intranet.

### BRIEF SUMMARY OF THE INVENTION

In a typical application, the computer program connects to a server on the Internet to retrieve a configuration file. The computer program then attaches itself to the network hosts and begins to sniff network packets. The computer program then extracts the Internet Protocol (IP) Addresses from the network packets and cross-references them with the configuration file. If the IP Addresses do not exist in the configuration file, the IP Address is added to a firewall rule created for blocking both incoming and outgoing traffic to the IP Address.

### BRIEF DESCRIPTION OF THE SEVERAL VIEWS OF THE DRAWING

FIG. 1 illustrates the methods for automatically adding Internet Protocol addresses to a firewall.

### DETAILED DESCRIPTIONS OF THE INVENTION

In accordance with various embodiments, mechanisms (which can include methods, systems, and media) for modifying firewalls based on IP addressed are provided.

In some embodiments, the mechanisms described herein can automatically add an IP address to a firewall's list of blocked IP addresses so that no network traffic can flow to and from the blocked IP addresses.

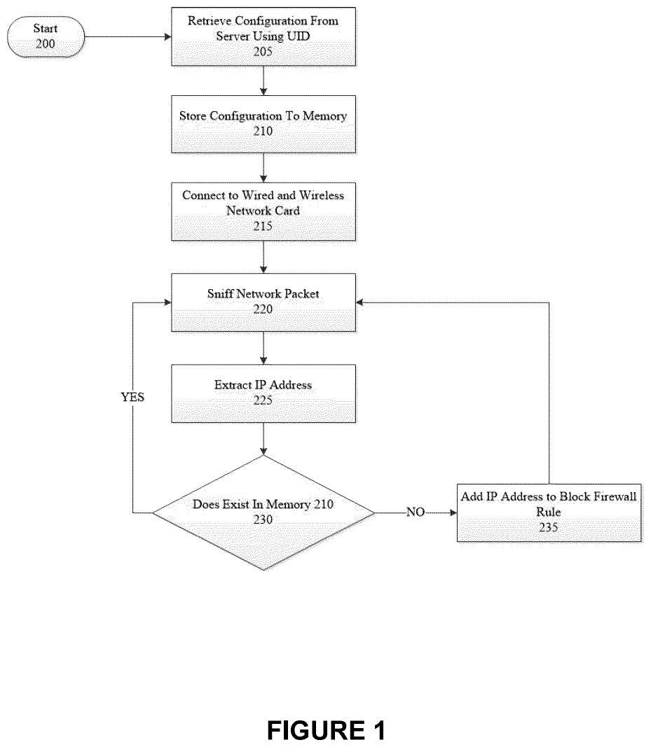

FIG. 1 illustrates the methods for automatically adding Internet Protocol (IP) addresses to firewall rule designed to block both incoming and outgoing traffic to specific IP addresses. The program starts at Step 200 and proceeds to Step 205. At Step 205, the program connects to a computer on the network or through the Internet to retrieve a configuration file using a unique identifier that represents the configuration file. The program then continues to Step 210 and stores the configuration data within the file to memory before continuing to Step 215. At Step 215, the program connects to either a wired or wireless network card before continuing to Step 220. At Step 220, the program begins to sniff network packets that travel through the network card. The program then continues to Step 225 where it extracts the IP addresses from the network packets before continuing to Step 230. At Step 230, the program checks to see if the IP addresses extracted from the network packets exists in memory of Step 210. If the IP addresses do not exist in the memory of Step 210, the program continues to Step 235 where it adds the IP addresses to the firewall rule designed to block both incoming and outgoing traffic before continuing to Step 220. If at Step 230, the IP addresses do exist in memory, the program then proceeds to Step 220.

What is claimed is:

1. A method for automatically adding Internet Protocol (IP) addresses comprising the steps of:
(a) retrieve configuration data from server
(b) storing configuration data to memory
(c) connecting to network hosts
(d) sniffing network traffics
(e) extracting IP Addresses from network packets
(f) cross-referencing IP Addresses with data of Step (b)
(g) adding IP Addresses to firewall created for blocking incoming and outgoing network traffic

2. The method of claim 1, wherein the program automatically adds IP addresses to firewall created for blocking incoming and outgoing network traffic.
